(19) United States
(12) Patent Application Publication
(10) Pub. No.: US 2025/0350220 A1
(43) Pub. Date: Nov. 13, 2025

(54) METHOD FOR ADAPTING A TARGET VOLTAGE VALUE FOR CONTROLLING A TAP-CHANGING TRANSFORMER, AND DEVICE FOR ADAPTING A TARGET VOLTAGE VALUE FOR CONTROLLING A TAP-CHANGING TRANSFORMER

(71) Applicant: Maschinenfabrik Reinhausen GmbH, Regensburg (DE)

(72) Inventors: Karsten Viereck, Regensburg (DE); Helmut Prölss, Regensburg (DE); Alexander Winterer, Lappersdorf (DE); Markus Riepl, Seubersdorf (DE)

(21) Appl. No.: 18/862,174

(22) PCT Filed: Apr. 19, 2023
(86) PCT No.: PCT/EP2023/060055

§ 371 Date: Nov. 1, 2024

(30) Foreign Application Priority Data
May 2, 2022 (DE) 10 2022 110 668.3

(51) Int. Cl. H02P 13/06; H02J 3/18

(52) U.S. Cl. CPC H02P 13/06; H02J 3/1878

(57) ABSTRACT

A method for adapting a target voltage value for voltage control of a tap-changing transformer by an on-load tap changer is provided. The method includes determining a reverse power flow on a low-voltage side of the tap-changing transformer by measuring a current and a voltage. The on-load tap changer is actuated from a current tap position n to a further tap position. A voltage of a current is measured in the further tap position. A value m is determined from powers of different tap positions, and the determined value m is used as a gradient for a first section of a straight line of the target voltage value.

### CROSS REFERENCE TO RELATED APPLICATIONS

This application is a U.S. National Phase application under 35 U.S.C. § 371 of International Application No. PCT/EP2023/060055, filed on Apr. 19, 2023, and claims benefit to German Patent Application No. DE 10 2022 110 668.3, filed on May 2, 2022. The International Application was published in German on Nov. 9, 2023 as WO 2023/213535 A1 under PCT Article 21(2).

### FIELD

The present disclosure relates to a method for adapting a target voltage value for controlling a tap-changing transformer by means of an on-load tap changer.

The present disclosure also relates to a device for adapting a target voltage value for controlling a tap-changing transformer.

### BACKGROUND

The active power is usually consumed by loads on the low-voltage side of a tap-changing transformer in a grid. In order to keep the voltage constant as consumption increases or decreases, the voltage is controlled by an on-load tap changer. However, since generators are increasingly found on the low-voltage side, a negative active power flow can occur. A new control concept may be required here.

### SUMMARY

In an embodiment, the present disclosure provides a method for adapting a target voltage value for voltage control of a tap-changing transformer by an on-load tap changer. The method includes determining a reverse power flow on a low-voltage side of the tap-changing transformer by measuring a current and a voltage. The on-load tap changer is actuated from a current tap position n to a further tap position. A voltage of a current is measured in the further tap position. A value m is determined from powers of different tap positions, and the determined value m is used as a gradient for a first section of a straight line of the target voltage value.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a power supply system;

FIG. 2 shows a circuit diagram of an idealized grid; and

FIG. 3 shows a graph for visualizing a voltage control operation.

### DETAILED DESCRIPTION

In accordance with an embodiment, the present disclosure provides a method for adapting a target voltage value for controlling a tap-changing transformer using an on-load tap changer, by way of which the voltage at the end consumer does not slip out of a predetermined voltage band and in addition the maximum load on the system, which corresponds to the current through the lines, is not exceeded.

In accordance with another embodiment, the present disclosure provides a method for adapting a target voltage value for voltage control of a tap-changing transformer by means of an on-load tap changer, wherein the method comprises the following steps:
determining a reverse power flow on a low-voltage side of the tap-changing transformer by measuring a current and a voltage;
actuating the on-load tap changer from a current tap position to a further tap position and measuring the voltage and the current in the further tap position;
determining a value m from the powers of the different tap positions;
using the determined value m as a gradient for a first section of a straight line of a target voltage value.

The method allows the target voltage value, which is used to control the on-load tap changer in the tap-changing transformer, to be easily adapted in a particularly efficient and rapid manner in the event of a reverse power flow and thus allows overvoltages at loads in the grid to be prevented. Furthermore, the method ensures maximum feed power. A fixed target voltage value does not allow the system to react to changes in the grid on the low-voltage side. The method allows, for example, a photovoltaic system in the grid to be easily connected, without this having a disadvantageous effect. The target voltage value is then accordingly adapted to the new conditions of the grid by the method. For this purpose, the powers (apparent power and/or active power) are ascertained at different tap positions after a reverse power flow has been established. The powers are based here on measured currents and voltages on the low-voltage side of the tap-changing transformer when the on-load tap changer moves to different tap positions. The quotient of the powers, once it has been determined, then maps the value m of the gradient of the straight line which represents the target voltage value.

The power can be determined in any desired manner, for example as apparent power and/or active power.

The reverse power flow can be determined in any desired manner, for example by measuring the current and the voltage on the low-voltage side of the tap-changing transformer. In particular, when reverse power flow is identified, the active current flows from the loads and the generators, that is to say from the low-voltage side, via the tap-changing transformer, to the high-voltage side.

The on-load tap changer can be configured in any desired manner and can be, for example, an on-load tap changer with a diverter switch and selector or selector switch. Furthermore, the on-load tap changer can have both mechanical switching elements, such as contacts and vacuum interrupters, or else semiconductor switching elements. The on-load tap changer can be actuated via a motor drive or electronic driving of the semiconductor switching elements.

The power can be determined in any desired manner, for example as the product of the measured current and measured voltage. Either the apparent power or the active power can be determined here.

The value m for the gradient for the first section of a straight line of a target voltage value is determined as the quotient of the powers of different tap positions of the on-load tap changer.

The method can be carried out in any desired manner, wherein the value m, after being determined, is used as the gradient in the first section of the straight line of the target voltage value.

The method can be carried out in any desired manner, wherein
the power in the current tap position is determined as the product of the measured current and the measured voltage in the current tap position;
the on-load tap changer is actuated and moved from a current tap position to a higher tap position;
the power of the higher tap position is determined as the product of the measured current and the measured voltage of the higher tap position;
the value m is determined as the quotient of the power of the higher tap position and the power of the lower tap position.

The value m, after being determined, is then used as the gradient in the first section of the straight line of the target voltage value and thus replaces the previous first section of the straight line.

The method can be carried out in any desired manner, wherein
the power in the current tap position is determined as the product of the measured current and the measured voltage in the current tap position;
the on-load tap changer is actuated and moved from a current tap position n to a lower tap position;
the power of the lower tap position is determined as the product of the measured current and the measured voltage of the lower tap position;
the value m is determined as the quotient of the power of the higher tap position n and the power of the lower tap position n−1.

The method can be carried out in any desired manner, wherein
the on-load tap changer is actuated and moved from a current tap position to a higher tap position;
the power of the higher tap position is determined as the product of the measured current and the measured voltage of the higher tap position;
the on-load tap changer is actuated twice and moved from a current tap position to the lower tap position;
the power of the lower tap position is determined as the product of the measured current and the measured voltage of the lower tap position;
the value m is determined as the quotient of the power of the higher tap position and the power of the lower tap position.

The method can be carried out in any desired manner, wherein
the on-load tap changer is actuated and moved from a current tap position to a low tap position;
the power of the lower tap position is determined as the product of the measured current and the measured voltage of the lower tap position;
the on-load tap changer is actuated twice and moved from a current tap position to the higher tap position;
the power of the higher tap position is determined as the product of the measured current and the measured voltage of the higher tap position;
the value m is determined as the quotient of the power of the higher tap position and the power of the lower tap position.

When determining the target voltage value, the on-load tap changer is always switched from the current tap position to an adjacent tap position. The voltage and the current are measured in the respective tap positions. The quotient of the powers of the higher tap position and the lower tap position forms the gradient of the straight line which maps the target voltage value. Higher and lower tap position here mean that the numerical value of the higher tap position of the on-load tap changer is higher than the numerical value of the lower tap position.

It is also possible to switch from a current tap position to a high tap position. The system then switches to the lower tap position twice. Voltage and current are correspondingly measured in the tap positions moved to. The value m for the gradient of the target voltage value is thus more accurate. The gradient triangle is larger and thus the determined value m is more accurate.

In accordance with another embodiment, the present disclosure provides a device for adapting a target voltage value for voltage control of a tap-changing transformer, comprising:
at least one measuring device for measuring a current and a voltage on the low-voltage side of the tap-changing transformer;
a control device, which is connected to the at least one measuring device for receiving the measured current and voltage.

The measuring device can be configured in any desired manner, for example can have a current sensor and a voltage sensor. These sensors are connected to the control device via cables or wirelessly. The device is designed and configured to carry out the above-described improved method for adapting a target voltage value for voltage control of a tap-changing transformer by means of an on-load tap changer and in particular to detect the measured currents and voltages, to determine a reverse power flow, to calculate the respective powers, to control the drive of the on-load tap changer, so that the on-load tap changer moves to different tap positions, to determine a value for the gradient of the straight line of the target voltage value and accordingly to change the straight line of the target voltage value and store it.

The device can be configured in any desired manner, wherein the tap-changing transformer is a variable-impedance longitudinal controller, in particular a high-voltage transformer.

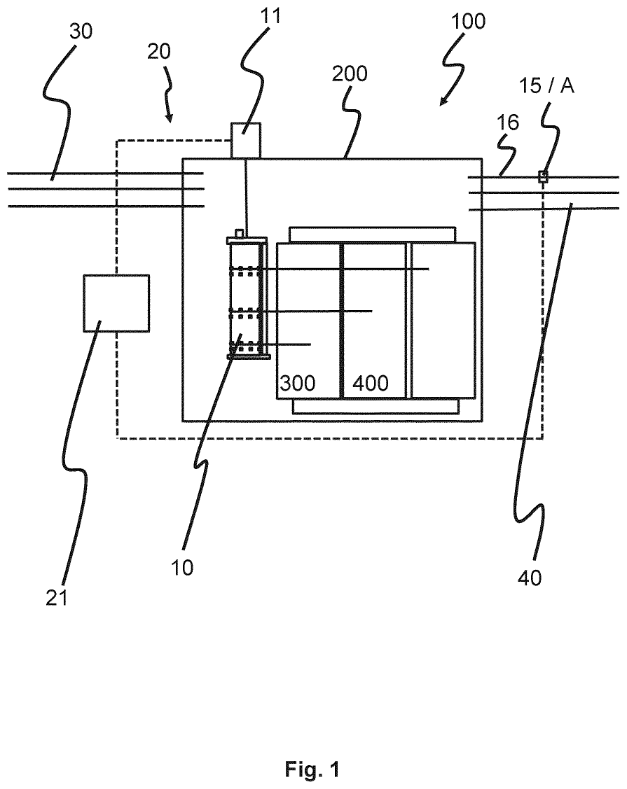

FIG. 1 shows a power supply system 100 comprising a tap-changing transformer 200 having a plurality of primary windings 300 and a plurality of secondary windings 400, which are inductively coupled. An on-load tap changer 10, which is coupled to the primary windings. The primary windings 300 have a plurality of taps. The on-load tap changer 10 is connected to the primary windings 300 via the taps. The on-load tap changer 10 is designed for switching the taps and thus for controlling the tap-changing transformer 200. A motor drive 11 actuates the on-load tap changer 10, as a result of which the taps are wired for controlling the tap-changing transformer 200. A device 20 for voltage control is also provided. The device 20 has a control device 21, which is connected to the motor drive 11 and a measuring device 15. The control device 21 is configured and designed to control the motor drive 11 and thus the actuation of the on-load tap changer 10, as a result of which the tap-changing transformer 200 is controlled.

The tap-changing transformer 200 is, on its first side 30, the high-voltage side, connected to the high-voltage grid. Furthermore, the tap-changing transformer 200 is, on its second side 40, the low-voltage side, connected to the low-voltage grid. For example, 110 KV is present on the high-voltage side and 20 kV is present on the low-voltage side. The grids are preferably three-phase grids here. The voltage of the first grid is usually converted into a lower voltage of the second grid by way of the tap-changing transformer 200. The tap-changing transformer 200 is preferably configured as a variable-impedance longitudinal controller or a high-voltage transformer.

The control device 21 of the device 20 on the tap-changing transformer 200 is provided for voltage control. Here, this control device 21 can be arranged directly on the transformer housing or separately in a control center.

In addition to the loads, generators can also be connected on the second side 40, that is to say on the low-voltage side, and therefore the voltage can fluctuate on this side or in this grid. These voltage fluctuations on the second side 40 can be compensated for by actuating the on-load tap changer 10 on the first side 30 of the first grid (high-voltage grid). For this purpose, at least one measuring device 15 is arranged on the low-voltage side and measures these changes in voltage and current. Specifically, the measuring device is at least one current sensor and at least one voltage sensor, which is arranged on at least one line 16 of the second grid (low-voltage grid). This measuring device 15 transmits the measured voltage and the measured current to the control device 21. Furthermore, the measuring device 15 can also be arranged on the high-voltage side, that is to say the first side 30.

Based on these transmitted currents and voltages, voltage control and thus in particular the actuation of the on-load tap changer 10 are performed via the motor drive 11 according to a method for voltage control.

The device 20 with the control device 21 has means or is configured and designed to additionally execute the method according to the present disclosure.

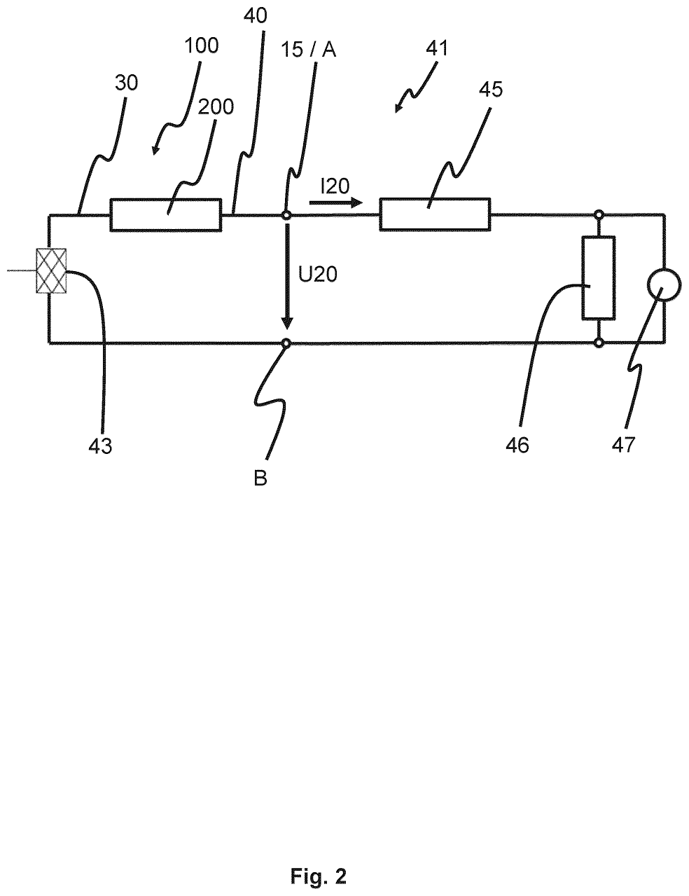

FIG. 2 shows a circuit diagram of an idealized grid 41 with the power supply system 100. The tap-changing transformer 200 is connected in the grid. A line with a line impedance 45, a load with a load impedance 46, a high-voltage grid with a grid impedance 43 and also a generator 47 are also shown in the circuit diagram of the grid 41. Here, the generator 47 represents all the elements (generators) that feed power into the grid and do not draw power from it. These elements may be, for example, photovoltaic systems, wind energy installations and thus, very generally, regenerative energy generators.

The line impedance 45 represents the impedance of all the lines (or high-voltage lines or cables).

The grid impedance 43 represents the impedance of the higher-level grid (high-voltage grid) at the connection point of the tap-changing transformer.

The tap-changing transformer 200 represents a controllable longitudinal impedance.

Since both loads and generators are connected to the grid 41, the situation may arise that not only is energy drawn from the high-voltage grid by the loads but is also fed by generators. Here, drawn means that mainly power (active power) is consumed by the loads on the second side 40—that is to say the low-voltage side. This is what is known as the forward power flow (FPF).

During feeding, power (active power) is supplied to the grid 41 from a source 47 by photovoltaic systems or the like on the second side 40. In other words, here, the active power flows from the load side, that is to say the second side 40, to the higher-level grid or power is transported from the low-voltage side to the high-voltage side. This is what is known as the reverse power flow (RPF).

When determining whether a reverse power flow or a forward power flow is present, a voltage U20 is measured between points A and B of the grid. Point A is located between the tap-changing transformer 200 and the line impedance 45, the load impedance 46 and the generator 47. Point B is downstream of the line impedance 45, load impedance 46 and the generator 47. Furthermore, a current I20 is measured directly at point A. All the measurements and in particular the measurements at point A are performed by means of the measuring device 15. In the case of a forward power flow, the current I20 (active current) flows from the high-voltage grid to the loads via the tap-changing transformer 200 and the lines. In the case of reverse power flow, the current (active current) I20 flows from the combination of the loads and generators via lines into the high-voltage grid via the tap-changing transformer 200. When a reverse power flow is measured at points A and B, the sign of the measured power (active power) is negative. When a forward power flow is measured at points A and B, the sign of the measured power (active power) is positive. Thus, the sign can be used to establish whether there is a reverse power flow or a forward power flow.

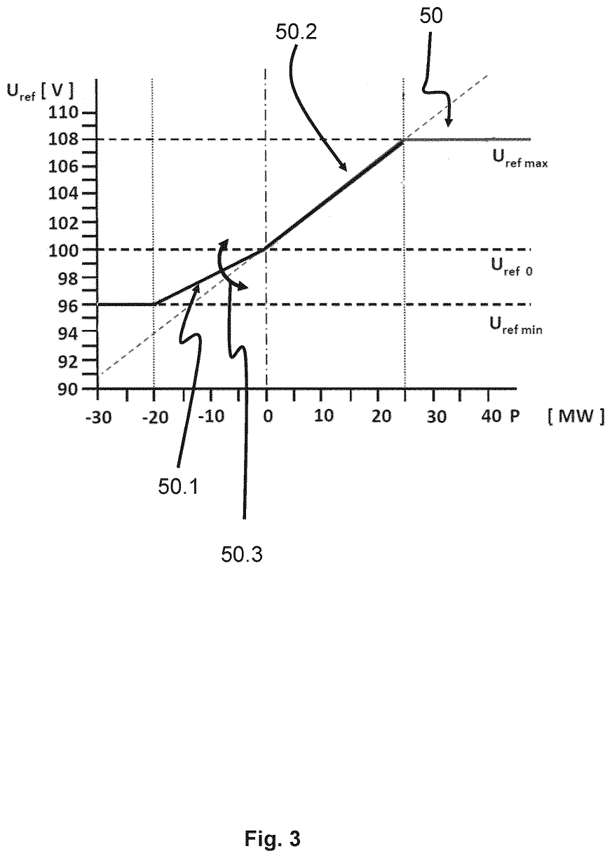

FIG. 3 shows a graph for visualizing the voltage control on a tap-changing transformer 200. The power (active power) P, which is drawn from or fed or supplied to the tap-changing transformer 200, is plotted on the X-axis. Here, drawn means that mainly power (active power) is consumed by the loads on the second side 40, that is to say the low-voltage side. This is what is known as the forward power flow (FPF).

During feeding, power (active power) is supplied to the power supply system 100 by photovoltaic systems or the like on the second side 40. In other words, here, power (active power) flows from the load side, that is to say the second side 40, to the grid or power is transported from the low-voltage side to the high-voltage side. This is what is known as the reverse power flow (RPF).

The zero point of the X-axis is plotted in the middle of the graph, so that a corresponding power state of the grid, that is to say a forward power flow or reverse power flow, can be mapped. This allows the graph to be divided into a first region in which forward power flow is present and into a second region in which reverse power flow is present. In the case of a forward power flow, the measured power is plotted in the positive direction on the low-voltage side. In the case of a reverse power flow, the measured power is provided with a negative sign.

A reference voltage Uref is plotted on the Y-axis. Here, for example, a reference voltage of 100 V is specified, wherein this can deviate by 10%, that is to say between 90 V and 110 V. As an alternative, any desired voltage value can be plotted here. Basically, the reference voltage Uref directly or indirectly maps the measured voltage on the second side 40 in the low-voltage grid.

A straight line 50, which serves as the target value for the device 20 for voltage control, is shown in the graph; this straight line 50 represents the target voltage value Utarget. During operation, therefore, the voltage Uactual of the tap-changing transformer 200 on the second side 40 is permanently monitored by means of at least one measuring device 15. These measured values for the voltages Uactual are shown in the graph. Depending on where the measured values are located in the graph, the on-load tap changer 10 is actuated via the motor drive 11 until the measured actual value of the voltage Uactual is at or in the immediate vicinity of the target voltage value Utarget, represented by the straight line 50. A voltage band or a tolerance range is specified around the target voltage value Utarget, that is to say also around the straight line 50, in which voltage band or tolerance range the actual value of the voltage Uactual may be located without actuation having to be performed.

The straight line 50 of the target voltage value Utarget is divided into a first section and a second section and may have a different gradient in each of the sections.

In the region of the forward power flow, that is to say when power is drawn by the loads, the straight line 50 has a defined specified gradient in the second section 50.2 of the target voltage value Utarget of the control operation. This gradient depends on certain grid parameters. These parameters are specified by the transmission lines (Rline, Lline) and the loads (Rload, Lload). These parameters can be easily determined and thus stored in the device 20 before commissioning.

This ensures that the voltage on the load side always remains in a specified band in spite of increasing load. The voltage is usually between 360 V and 440 V.

In the region of the reverse power flow, that is to say when power is fed on the low-voltage side, the straight line 50 has a different gradient in the first section 50.1 of the target voltage value Utarget in this section of the control operation, this gradient differing from the gradient in the region of the forward power flow, however. This gradient can also be defined using the grid parameters before commissioning. However, for this purpose, the parameters for the transmission line and the generators have to be known. However, these parameters are often not present or may change over time.

However, the method according to the present disclosure allows the gradient of the straight line of the target voltage value Utarget to be dynamically adapted. This is to be symbolized by the double-headed arrow 50.3. The grid parameters do not have to be specified here.

An exemplary method sequence for adapting a target voltage value Utarget for voltage control of a tap-changing transformer 200 by means of an on-load tap changer 10 is described below.

In a first step, the power flow is determined. Specifically, it is determined whether a reverse power flow or a forward power flow is present. For this purpose, the direction of the current I20 or the sign of the active current and the voltage U20 are determined and used to derive whether a reverse power flow or a forward power flow is present. The current I20 measured at point A of a grid and the voltage U20 are detected via the measuring device 15 and determined in the device 20. Furthermore, the power L20 is determined as the product of the measured voltage U20 and I20. The power may be apparent power or active power.

A reverse power flow is present when the active power derived from the voltage U20 and the current I20 is negative (has a negative sign), that is the active current at point A flows from the generator to the grid via the transformer 200.

A forward power flow is present when the active power derived from the voltage and the current is positive, that is the active current at point A flows from the grid to the load via the transformer 200.

In a further step, the on-load tap changer 10 in the tap-changing transformer 200 is actuated in such a way that it is moved from the current output tap position n to a next higher tap position n+1 or alternatively is moved to a next lower tap position n−1. Here, the first current I21 and a first voltage U21, and the resulting power L21, are determined if a switch is made to a higher tap position. If, however, a switch is made to a next lower tap position n−1, a second current 119 and a second voltage U19 and the resulting power L19 are determined.

In a subsequent step, the on-load tap changer 10 is switched to the original tap position n.

In a next step, a value m is determined from the measured powers in the approached tap position and the current tap position. The value m is always formed as the quotient of the power of the higher tap position and of the lower tap position. Higher and lower tap position here mean that the numerical value of the higher tap position of the on-load tap changer is higher than the numerical value of the lower tap position. In the case of the previous upward switching, the value m is thus the quotient of the power L21 of the higher tap position n+1 and the power L20 of the current tap position n or, when switching downward or approaching a lower tap position or tap changer position, the value m is the quotient of the power L20 of the current tap position n and the power L19 of the lower tap position n−1.

In a next step, the ascertained value m is used as the gradient for the straight line 50 of the target voltage value Utarget in the first section 50.1 of the reverse power flow. This new straight line section forms the target voltage value Utarget and is used to control the on-load tap changer 10.

The equation for the straight line of the target voltage value Utarget is then y=m*x. This target voltage value Utarget is determined by means of the device 20 for voltage control and in particular a control device 21. Thus, the device 20 is not only used for voltage control of the tap-changing transformer 200, but is also able to adapt the target voltage value Utarget. This adaptation can be carried out as often as desired, in particular in the event of a change in weather conditions. For example, when clouds move over large photovoltaic systems; when the feed power changes, that is reverse power flow with a high gradient, or grid configurations are connected or disconnected.

A further exemplary method sequence for adapting a target voltage value Utarget for voltage control of a tap-changing transformer 200 by means of an on-load tap changer 10 is described below.

Here, too, the power flow is determined in a first step. Specifically, it is determined whether a reverse power flow or a forward power flow is present. For this purpose, the direction of the current (active current) I20 and the voltage U20 are determined and used to derive whether a reverse power flow or a forward power flow is present. The current I20 measured at point A of a grid and the voltage U20 are detected via the measuring device 15 and determined in the device 20.

A reverse power flow is present when the active power derived from the voltage U20 and the current I20 is negative (or has a negative sign), that is the current at point A flows from the generator to the grid via the transformer 200.

A forward power flow is present when the power derived from the voltage and the current is positive, that is the current at point A flows from the grid to the load via the transformer 200.

In a further step, the on-load tap changer 10 in the tap-changing transformer 200 is actuated in such a way that it is moved from the current output tap position n to a next higher tap position n+1. The first current I21 and a first voltage U21, and the resulting power L21, are determined here. The power may be apparent power or active power.

In a further step, the on-load tap changer 10 in the tap-changing transformer 200 is actuated in such a way that it is moved downward twice from the current output tap position n+1 to a lower tap position n−1. Here, the second current 119 and a second voltage U19, and the resulting power L19, are determined. The power may be apparent power or active power.

In a subsequent step, the on-load tap changer 10 is switched to the original tap position n.

In a next step, a value m is determined from the measured powers L21 in the approached tap positions n+1 and the measured power L19 of the second approached tap positions n−1. The value m is always formed as the quotient of the power of the higher tap position and of the lower tap position. Higher and lower tap position here mean that the numerical value of the higher tap position of the on-load tap changer is higher than the numerical value of the lower tap position. In this case, the value m is thus the quotient of the power L21 of the higher tap position n+1 and the power L19 of the tap position n−1.

In a next step, the ascertained value m is used as the gradient for the straight line 50 of the target voltage value Utarget in the first section 50.1 of the reverse power flow. This new straight line forms the target voltage value Utarget. The equation for the straight line of the target voltage value is then y=m*x. This target voltage value Utarget is determined by means of the device 20 for voltage control and in particular a control device 21. Thus, the device 20 is not only used for voltage control of the tap-changing transformer 200, but is also able to adapt, to change and to store the target voltage value Utarget. This adaptation can be carried out as often as desired.

As an alternative, a switch can initially be made downward to the tap position n−1 once and upward to the tap position n+1 twice. In comparison to the method described above, the quotient of the powers of the tap positions that are further apart is more accurate than the quotient of the powers of the tap positions that are closer together.

The device 20 with the control device 21 has means or is configured and designed to execute the above-described methods.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

10 On-load tap changer
11 Motor drive
15 Measuring device
16 Line
20 Device
21 Control device
30 First side of 200
40 Second side of 200
41 Grid
43 Grid impedance of the high-voltage grid
45 Line impedance
46 Load impedance
47 Generator
50 Target voltage value Utarget
50.1 First section of 50
50.2 Second section of 50
50.3 Double-headed arrow
100 Power supply system
200 Tap-changing transformer
300 Primary winding
400 Secondary winding

1. A method for adapting a target voltage value for voltage control of a tap-changing transformer by an on-load tap changer, wherein the method comprises:
determining a reverse power flow on a low-voltage side of the tap-changing transformer by measuring a current and a voltage;
actuating the on-load tap changer from a current tap position n to a further tap position and measuring a voltage of a current in the further tap position;
determining a value m from powers of different tap positions; and
using the determined value m as a gradient for a first section of a straight line of the target voltage value.

2. The method as claimed in claim 1, wherein
defining the value m, after being determined, as the gradient of the straight line in the first section of the target voltage value and replacing the straight line in the first section.

3. The method as claimed in claim 1, further comprising:
determining a power in the current tap position as a product of a measured current and a measured voltage in the current tap position;
actuating and moving the on-load tap changer from the current tap position to a higher tap position;
determining a power of the higher tap position as a product of a measured current and a measured voltage of the higher tap position;
determining the value m as a quotient of the power of the higher tap position and the power of the current tap position.

4. The method as claimed in claim 1, further comprising:
determining a power in the current tap position as a product of a measured current and a measured voltage in the current tap position;
actuating and moving the on-load tap changer from the current tap position to a lower tap position;
determining a power of the lower tap position as a product of a measured current and a measured voltage of the lower tap position;
determining the value m as a quotient of the power of the current tap position n and the power of the lower tap position.

5. The method as claimed in claim 1, further comprising:
actuating and moving the on-load tap changer from the current tap position to a higher tap position;
determining a power of the higher tap position as a product of a measured current and a measured voltage of the higher tap position;
actuating the on-load tap changer twice and moving the on-load tap changer from the higher tap position to a lower tap position;
determining a power of the lower tap position as a product of a measured current and a measured voltage of the lower tap position;
determining the value m as a quotient of the power of the higher tap position and the power of the lower tap position.

6. The method as claimed in claim 1, further comprising:
actuating and moving the on-load tap changer from the current tap position to a lower tap position;
determining a power of the lower tap position as a product of a measured current and a measured voltage of the lower tap position;
actuating the on-load tap changer twice and moving the on-load tap changer from the lower tap position to a higher tap position;
determining a power of the higher tap position as a product of a measured current and a measured voltage of the higher tap position;
determining the value m as a quotient of the power of the higher tap position and the power of the lower tap position.

7. The method as claimed in claim 1, wherein
the powers are either an apparent power and/or an active power.

8. A device for adapting a target voltage value for voltage control of a tap-changing transformer, comprising:
at least one measuring device for measuring a current and a voltage on a low-voltage side of the tap-changing transformer;
a control device, which is connected to the at least one measuring device for receiving the measured current and voltage; and
the control device being configured to carry out a method as claimed in claim 1.

9. The device for adapting the target voltage value for voltage control of the tap-changing transformer as claimed in claim 8, wherein
the tap-changing transformer is an autotransformer.
